(19) United States
(12) Patent Application Publication
(10) Pub. No.: US 2013/0134787 A1
(43) Pub. Date: May 30, 2013

(54) BATTERY SYSTEM

(71) Applicant: Kazuyuki Sakakibara, Okazaki-shi (JP)

(72) Inventor: Kazuyuki Sakakibara, Okazaki-shi (JP)

(21) Appl. No.: 13/688,883

(22) Filed: Nov. 29, 2012

(30) Foreign Application Priority Data
Nov. 30, 2011 (JP) 2011-261577

(51) Int. Cl. H02J 7/00

(52) U.S. Cl. CPC H02J 7/0068; H02J 7/0047
USPC 307/72

(57) ABSTRACT

A battery system is disclosed which includes: a battery assembly; an AC-voltage generator for generating alternate current (AC) voltage from direct current (DC) voltage of the battery assembly; a battery charger for charging the battery assembly; and a detector for detecting application of AC voltage from the AC-voltage generator to the battery charger.

### CROSS-REFERENCE TO RELATED APPLICATIONS

This application claims the priority benefit of Japanese Patent Application No. 2011-261577, filed Nov. 30, 2011, the content of which is incorporated herein by reference in its entirety.

### BACKGROUND OF THE INVENTION

1. Field of the Invention

The present invention relates to a battery system, that is, a power source that supplies electric power generated by a rechargeable battery such as a Li-ion battery to an electric device for operation of the electric device.

2. Description of the Related Art

Typically, an electric device is powered by alternate-current (AC) voltage supplied from a commercial power source. However, for the use of such a commercial power source, its electrical outlet may be located at a limited number of particular positions, and a user of the commercial power source may encounter situations, such as an emergency situation, where the user cannot obtain any electric power from the electrical outlet. For these reasons, in recent years, a battery system has been launched onto the market, which contains a built-in rechargeable battery such as a Li-ion battery, and allows electric power stored in the rechargeable battery to be converted into AC voltage, to thereby supply power to an electric device, independently of a power line of the commercial power source.

### BRIEF SUMMARY OF THE INVENTION

For example, in such a battery system that allows (direct current) DC voltage outputted from a rechargeable battery such as a Li-ion battery to be converted into AC voltage, a state-of-charge (SOC) level of the rechargeable battery is decreasing as the battery system's operation continues to supply the AC voltage to an electrical device, and finally the rechargeable battery has become disabled from discharging any electric power. Therefore, the rechargeable battery with a reduced SOC level must be charged.

In order to charge a rechargeable battery, charging circuitry is required which is configured to convert AC voltage supplied from a commercial power source into DC voltage, and, in order to input the AC voltage into the charging circuitry, an input terminal for connection with the commercial power source is also required. More specifically, the input terminal is an input plug that can be connected with an electrical terminal from which the commercial power source outputs AC voltage.

On the other hand, in such a battery system that allows DC voltage outputted from a rechargeable battery to be converted into AC voltage and allows the AC voltage to be supplied to an electric device, an output terminal is required which can be connected with a power-input plug (i.e., an inlet terminal) that an electric device has, that is, an power outlet which is identical in shape to the outlet of the commercial power source.

Therefore, with respect to mating configurations, a relationship between the power outlet and the input plug both of which are included in the battery system is identical to a relationship between the outlet of the commercial power source and the power-input plug of the electric device. Due to this, there is an unavoidable possibility that the user can inadvertently connect the input plug of the battery system with the power outlet of the same battery system (hereinafter, referred to as a “self-inclusive loop-back connection”).

In addition, the power outlet and the input plug both of which are included in the battery system, have shapes that mate with each other, and, therefore, a non-self-inclusive loop-back connection can be made between a plurality of units of battery systems, in addition to the possibility that the self-inclusive loop-back connection can be made in one unit of a battery system alone. More specifically, the non-self-inclusive loop-back connection is made when the battery systems are interconnected in series, excepting a trailing end one of them, such that an input plug of a first one of the battery systems (i.e., a leading end one of the battery systems) is connected with an power outlet of a second one of the battery systems, and an input plug of the second battery system is connected with an power outlet of a third one of the battery systems, and finally an input plug of an n-th one of the battery systems (i.e., the trailing end battery system) is connected with an power outlet of the first battery system.

If an undesirable loop-back connection, whether self-inclusive or not, is made in one or more battery systems, failure can occur in one or more circuits within the battery system(s). Even if the circuit(s) has no failure, the SOC level of a rechargeable battery of each battery system decreases because of continuous consumption of electricity of the circuit(s), resulting in degraded function of the battery system(s). In addition, if a user sees the battery system(s) undesirably experiencing a loop-back connection, still keep operating without causing any failures, then the user also views the battery system(s) as even short-circuited, and the user is fearful of continuation of this undesirable operation of the battery system(s). Therefore, it is desirable to avoid further continued operation of the battery system(s) in case the battery system(s) encounters a loop-back connection, from the both aspects of preventing the very power source from failing, and of giving reassurance to the user.

### GENERAL OVERVIEW OF THE INVENTION

In view of the foregoing, it would be desirable to prevent a battery system from keeping operating in case the battery system encounters an undesirable loop-back connection.

According to one aspect of the invention, a battery system is provided, which comprises:

a battery assembly;

an AC-voltage generator for generating alternate current (AC) voltage from direct current (DC) voltage of the battery assembly;

a battery charger for charging the battery assembly; and

a detector for detecting application of AC voltage from the AC-voltage generator to the battery charger.

In this regard, the “AC-voltage generator” may include, but is not limited to, for example, an inverter; a converter; a circuit including a low-voltage battery, a voltage booster, and a DC-AC converter; a circuit including a high-voltage battery and a DC-AC converter, not including a voltage booster; and a device including an ultra-high-voltage battery, a voltage reducer, and a DC-AC converter.

One exemplary implementation of this battery system further comprises an electrically-operated switch configured to operate such that, in the presence of AC voltage inputted into the battery charger, the switch connects an output port of the AC-voltage generator with an input port of the battery charger, and, in the absence of AC voltage inputted into the battery charger, the switch does not connect the output port of the AC-voltage generator with the input port of the battery charger.

In this regard, the “switch” may include, but is not limited to, for example, a Field-Effect Transistor (FET).

Another exemplary implementation of this battery system further comprises a controller configured to at least partially inhibiting the AC-voltage generator from affecting the battery charger, in response to detection of the application of the AC voltage from the AC-voltage generator to the battery charger.

In this regard, the “controller” may be, but not limited to, for example, of a type of deactivating the AC-voltage generator, or a type of interrupting a connection between the AC-voltage generator and the battery charger, without deactivating the AC-voltage generator.

Still another exemplary implementation of this battery system further comprises an indicator providing an indication varying in response to detection of the application of the AC voltage from the AC-voltage generator to the battery charger.

In this regard, the “indicator” may include, but is not limited to, for example, a visual indicator such as one or more or electric lamps (e.g., LEDs) each of which is independently controllable, and a display having a 2-dimensional array of pixels or dots (e.g., a liquid crystal display (LCD)), an audio indicator such as a buzzer, and a tactual indicator such as a vibrator, and may be, for example, of an exclusive type or a multi-purpose type.

The invention may be embodied in the following non-limiting modes. These modes will be stated below such that these modes are divided into sections and are numbered, and such that these modes depend upon other mode(s), where appropriate. This facilitates a better understanding of some of the plurality of technical features and the plurality of combinations thereof disclosed in this specification, and does not mean that the scope of these features and combinations should be interpreted to limit the scope of the following modes of the invention. That is to say, it should be interpreted that it is allowable to select the technical features, which are stated in this specification but which are not stated in the following modes, as technical features of the invention.

Furthermore, reciting herein each one of the selected modes of the invention in a dependent form so as to depend from the other mode(s) does not exclude the possibility of the technical features in the dependent-form mode from becoming independent of those in the corresponding dependent mode(s) and to be removed therefrom. It should be interpreted that the technical features in the dependent-form mode(s) may become independent according to the nature of the corresponding technical features, where appropriate.

(1) A battery system used as a power source for an electric device, comprising:

a battery cell group formed with a plurality of battery cells;

a power-output section configured to convert DC voltage of the battery cell group into AC voltage and to output the AC voltage;

a power-output terminal allowing for supply of electric power from the power-output section to the electric device;

a charger configured to receive AC voltage, to convert the AC voltage into DC voltage, and to charge the battery cell group with the DC voltage;

a power-input terminal allowing for entry of electric power into the charger;

a detector configured to detect at least one of an electric voltage and an electric current occurring at the power-input terminal and an associated electric voltage and an associated electric current that varies depending on the electric voltage and the electric current occurring at the power-input terminal, respectively;

determining section configured to determine whether loop-back connection is present or not, based on results of the detector (e.g., the length of time lapsing from an occurrence time of a specific event (e.g., activation of the power-output section to output the AC voltage), to an occurrence time of a specific change in an output signal of the detector (an event in which the voltage indicated by the output signal of the detector changes from DC voltage to AC voltage, or an event in which the amplitude of the voltage indicated by the output signal of the detector exceeds a threshold),

wherein the loop-back connection includes at least one of first loop-back connection which is established if the power-output section of the battery system and the power-input terminal of the battery system are electrically interconnected, and second loop-back connection which is established if the power-output section of the battery system ant the power-input terminal of an additional battery system are electrically interconnected and the power-output section of the additional battery system and the power-input terminal of the battery system are electrically interconnected.

(2) The battery system according to mode (1), further comprising:

a controller configured to control activation or deactivation of the power-output section and the charger,

wherein the determining section is configured to determine that the loop-back connection is present, if the detector detects a state in which AC voltage enters the power-input terminal within a predetermined length of time since the power-output section starts outputting AC voltage, and to cause the controller to deactivate at least one of the power-output section and the charger.

(3) The battery system according to mode (1) or (2), further comprising:

a display,

wherein the determining section is configured to determine that the loop-back connection is present, if the detector detects a state in which AC voltage enters the power-input terminal within a predetermined length of time since the power-output section starts outputting AC voltage, and to change a display status of the display.

The invention would allow, if one or more battery systems encounter a loop-back connection, the battery system(s) to automatically terminate continued execution of undesirable operation in which the battery system(s) is still working, or a user to be alerted to the current execution of the undesirable operation, and then be prompted for an action to terminate continued execution of the undesirable operation.

It is noted here that, as used in this specification, the singular form “a,” “an,” and “the” include plural reference unless the context clearly dictates otherwise. It is also noted that the terms “comprising,” “including,” and “having” can be used interchangeably.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a functional block diagram illustrating a representative one of battery modules that are housed within a battery system according to an illustrative embodiment of the present invention;

FIG. 2 is a functional block diagram illustrating the entire battery system;

FIG. 3 is a flowchart illustrating a control sequence of the battery system depicted in FIG. 2;

FIG. 4 is a functional block diagram illustrating the battery system depicted in FIG. 2, which experiences a self-inclusive loop-back connection; and

FIG. 5 is a functional block diagram illustrating the battery system depicted in FIG. 2, with another battery system connected to together make a non-self-inclusive loop-back connection.

### DETAILED DESCRIPTION OF THE INVENTION

Several presently preferred embodiments of the invention will be described in more detail by reference to the drawings in which like numerals are used to indicate like elements throughout.

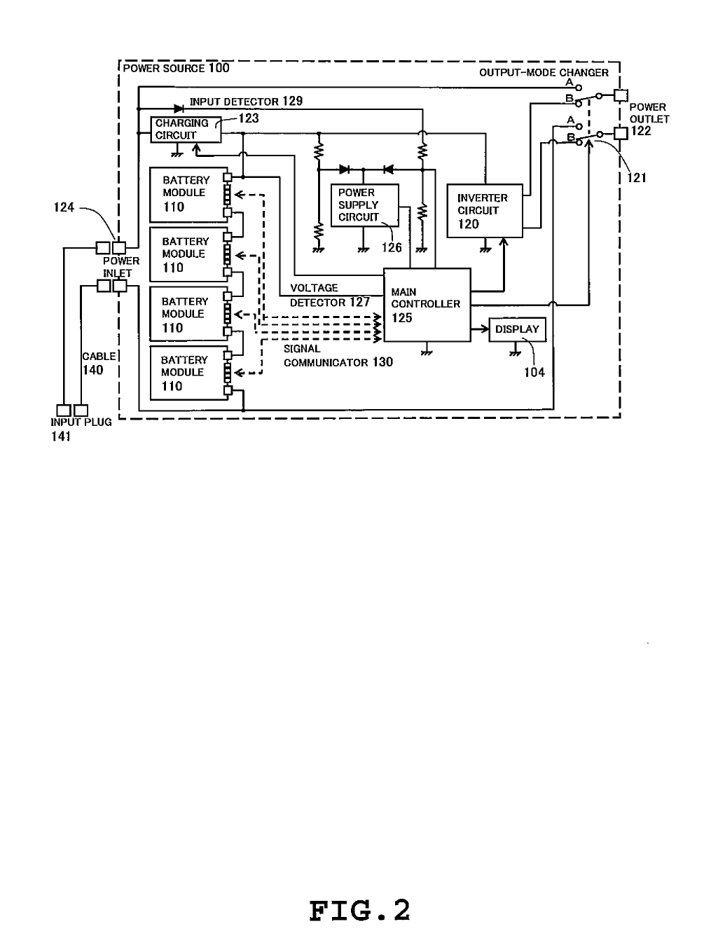

There will be next described in detail with reference to the drawings, a power source 100 (see FIG. 2) which is one example of a battery system according to an exemplary illustrative embodiment of the invention.

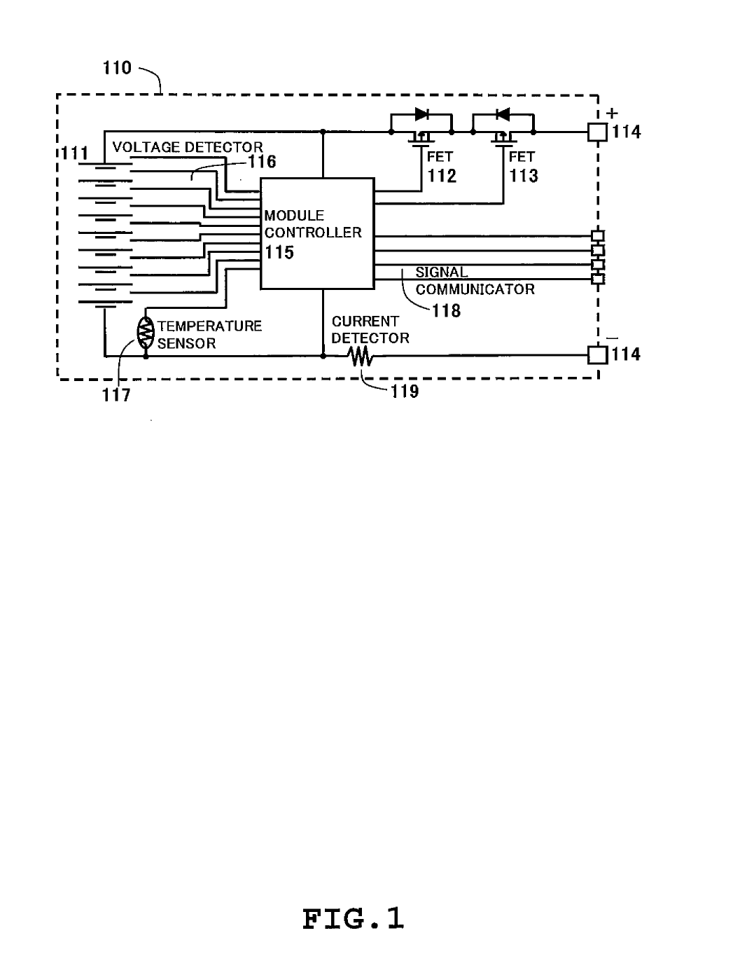

FIG. 1 is a functional block diagram illustrating a representative one of battery modules 110 that are housed within the power source 100. Each battery module 110 houses nine (9) battery cells 111 (e.g., each in the form of a Li-ion battery).

The nine (9) battery cells 111 are interconnected in series, and are electrically connected with a battery module terminal (including a plurality of terminal ends) 114 through an FET (Field-Effect Transistor) 112 for battery module charging (i.e., one example of a switching device or a current interrupt device) and an FET 113 for battery module discharging.

A battery module controller 115 detects the state of the battery cells 111 using at least one of a voltage detector 116 for detecting an electric voltage of each battery cell 111, a temperature detector 117 for detecting the temperature of the battery dells 111, and a current detector 119 for detecting an electric current occurring in the battery cells 111, and controls the FETs 112 and 113, based on the results of the detectors 116, 117 and 119, to permit or interrupt the flow of a charging electric current and/or a discharging electric current.

In addition, the battery module controller 115 includes a signal communicator 118 (e.g., a transceiver, a signal transmit/receive device, a device that performs wired or wireless communication), and, through the signal communicator 118, the battery module controller 115 receives a signal from and transmits a signal to a main controller 125 as described below.

FIG. 2 illustrates the power source 100 in a functional block diagram.

Four (4) battery modules 110 are interconnected in series, via the battery module terminal 114, are connected with a power outlet 122 through an inverter circuit 120 (i.e., an exemplary AC-voltage generator) having input and output ports and an output-mode changer 121 (i.e., an exemplary electrically-operated switch) having input and output ports, and are connected with a power inlet 124 through a charging circuit 123 (i.e., an exemplary battery charger) having two input ports A and B and one output port.

The power inlet 124 is connected with the input port of the charging circuit 123, the output port of the charging circuit 123 is connected with the input port of the inverter circuit 120 and the battery module terminal 114, the output port of the inverter circuit 120 is connected with one of the input ports A and B selected by the output-mode changer 121, and the output port of the output-mode changer 121 is connected with the power outlet 122.

The main controller 125, when the four (4) serially-interconnected battery modules 110 are electrically connected with each other for electric conduction, is powered by electric power supplied from the battery modules 110 for activation of the main controller 125. On the other hand, the main controller 125, when at least one of the battery modules 110 is not electrically connected with other battery modules 110 for electric conduction and the main controller 125 cannot be powered by electric power supplied from the four (4) serially-interconnected battery modules 110, is powered by electric power supplied from a power supply circuit (e.g., an electric power storage that stores electricity and is rechargeable) 126 for activation of the main controller 125.

The main controller 125 is electrically connected with a voltage detector 127 for detecting an electric voltage of the battery modules 110, an input detector 129 for detecting entry of electric power into the power inlet 124, and a display 104 for displaying the SOC level of the battery cells 111 housed within the battery module 110 and the operational state of the power source 100. The display 104 is a device that displays information in a changeable display status responsive to an external signal. The display 104 may be in the form of, for example, an LED (Light-Emission Diode) indicator that can change a display status such as an on- or off-state of lighting, color choices, brightness choices and choices of a visual pattern, or an LCD (Liquid Crystal Display) that can change a display status such as how pictures or characters are displayed on a display screen.

A cable 140 has one of both terminal ends, at which the cable 140 can be electrically connected with the power inlet 124, and the cable 140 has the other terminal end in the form of an input plug 141. The input plug 141 has a shape that can mate with the outlet of the commercial power source, and, although not illustrated, the input plug 141 is substantially the same in shape as a power-input plug (i.e., a power inlet terminal) of a electric device that can operate by being powered by the power source 100.

In addition, the main controller 125 receives signals from and transmits signals to the battery module controllers 115 each of which is housed within each battery module 110, through a signal communicator 130 (e.g., a device that can perform wired or wireless communication) and the signal communicator 118 within each battery module 110.

The battery module controller 115 determines whether the charging is permitted and whether the discharging is permitted, based on the electric voltage of each battery cell 111 and the temperature and the electric current of the battery cells 111, or based on the signal received from the main controller 115, and the battery module controller 115 controls the FETs 112 and 113, to thereby selectively permit and inhibit an input/output operation of the battery cells 111.

In addition, the battery module controller 115 transmits to the main controller 125 a signal indicative of a state of the above-described battery cells 111 with respect to the electric voltage, the temperature and the electric current, and a signal indicative of permission or inhibition of charging and discharging the battery cells 111.

The main controller 125 determines whether to permit the charging and the discharging, based on the electric voltage of the serially-interconnected battery modules 110, or based on the signal received from each battery module 110, and the main controller 125 controls the output-mode changer 121, the charging circuit 123 and the inverter circuit 120, to thereby select one of the input ports A and B, to thereby selectively execute and terminate the charging operation, and to thereby selectively activate and deactivate the inverter circuit 120 to permit its output operation and to inhibit its output operation. In addition, the main controller 125 transmits to the battery module controller 115 a signal indicative of permission or inhibition of an input/output operation of each battery module 110, based on the determination made by the main controller 125 about whether to permit the charging operation and whether to permit the output operation of the inverter circuit 120.

The inverter circuit 120, serving as one example of a voltage converter that converts DC voltage of the serially-interconnected battery modules 110 into AC voltage, is configured to output pseudo AC voltage having a waveform that is the same as that of a sine wave of AC voltage produced by the commercial power source.

The main controller 125 operates such that, if the main controller 125 detects, with the aid of the battery module controller 115, that the battery cells 111 are situated in a state where a discharging operation is not permitted, such as overdischarging, high-temperature and overload, then the main controller 125 deactivates the inverter circuit 120.

The charging circuit 123 receives AC voltage through the cable 140 connected with the power inlet 124, converts the inputted AC voltage into DC voltage, and charges a battery cell group housed within the battery module 110 with the DC voltage. Particularly, when the battery cell 111 is a Li-ion battery, it is preferable that the battery-cell current is controlled below its predetermined upper limit, until the battery cell voltage reaches a predetermined level of voltage, and, after that, the battery cell does not exceed the predetermined voltage during the charging operation of the battery cell group.

The main controller 125 operates such that, if the main controller 125 detects, with the aid of the battery module controller 115, that the battery cells 111 are situated in a state where a charging operation is inhibited, such as overcharge, high temperature, and over-current charging, then the main controller 125 deactivates the charging circuit 123.

In addition, the main controller 125 is electrically connected with the input detector 129 and detects application of electric voltage that can be used for the charging of the battery cells 111 to the power inlet 124, to thereby selectively perform and halt the charging operation.

The main controller 125, based on a control sequence as described below, controls the output-mode changer 121, such that the output-mode changer 121 connects its output port (connected with the power outlet 122) with the input port A of the output-mode changer 121, which is connected with the power inlet 124, or otherwise the output-mode changer 121 connects its output port with the input port B of the output-mode changer, which is connected with the output port of the inverter circuit 120. This allows an output mode of a voltage through the power outlet 122, to shift between a first mode in which AC voltage supplied from commercial power source through the power inlet 124 is outputted through the power outlet 122, and a second mode in which AC voltage outputted from the inverter circuit 120 is outputted through the power outlet 122.

The power supply circuit 126, having battery backup function, includes an internal electricity-storage-device such as a Li-ion battery, which is independent of the battery cell group housed within the battery module 110. The power supply circuit 126 operates such that, if the four (4) serially-interconnected battery modules 110 are not in an electrical conduction state, which disallows the following devices, including the main controller 125, the inverter circuit 120, the charging circuit 123, the input detector 129, the display 104 and the like, to be powered by the battery modules 110, then the power supply circuit 126, instead of the inactive battery modules 110, supplies these devices with electric power, for aiding these devices in performing an operation such as activation. In addition, the power supply circuit 126 operates such that, if the four (4) serially-interconnected battery modules 110 are in an electrical conduction state, then the power supply circuit 126 receives electric power from the battery modules 110 or the charging circuit 123 to charge the above-described internal electricity storage device.

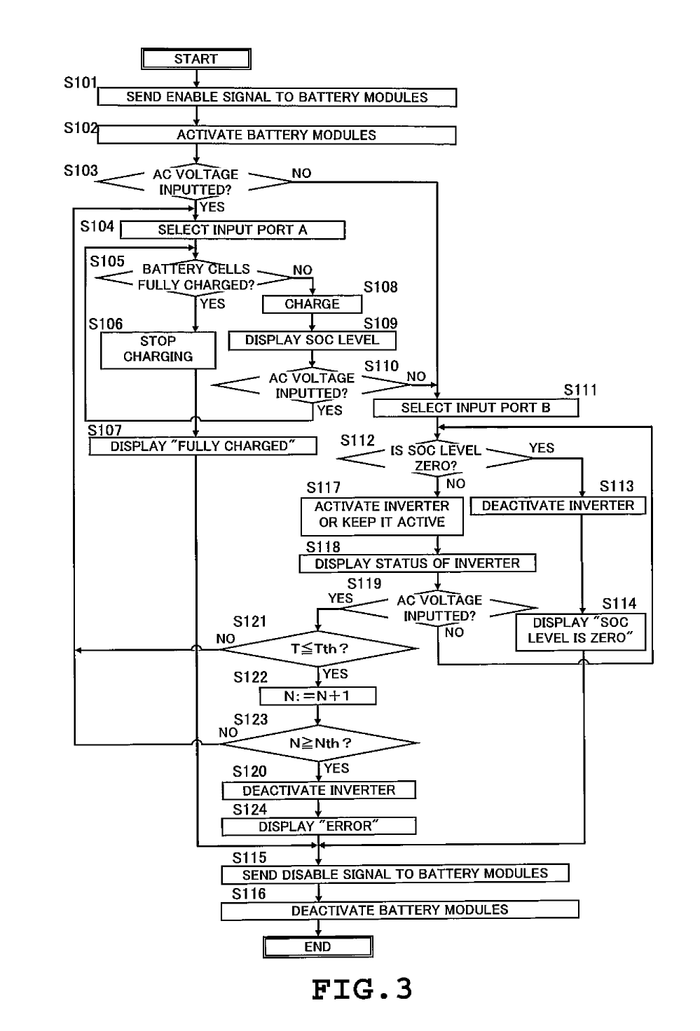

FIG. 3 is a flowchart illustrating a control sequence of the power source 100.

In step S101, the main controller 125 transmits to the battery module controller 115 of each battery module 110 an enable signal permitting electrical conduction between the battery cells 111 within each battery module 110. The enable signal may be transmitted, for example, although not illustrated, when a user-operable main switch electrically connected with the power source 100 for selectively activating the power source 100, is turned on, or when a switch operable in response to movement to an open state and a closed state of a movable protective cover disposed on the power source 100 for protecting the power outlet 122 from undesirable intrusion of external particles or water, detects that the cover is an open state allowing an power input plug of an external electrical device to be plugged in the power outlet 122. It is noted that electric power supplied from the power supply circuit 126 may be preferably used for monitoring the status of these switches, and transmitting the enable signal.

In step S102, the battery module controller 115 of each battery module 110 receives the enable signal and turns on the FETs 112 and 113. This brings all of the battery modules 110 within the power source 100 into an electrical conduction state, enabling the inverter circuit 120 to output electric power, and the charging circuit 123 to charge the battery cells 111.

In step S103, the main controller 125 determines, based on a signal from the input detector 129, whether the AC voltage of the commercial power source or the like, is inputted into the power inlet 124. If so, then the process proceeds to step S104 (the branch of step S103 is “Yes”), and if not so, then the process proceeds to step S111 (the branch of step S103 is “No”).

In step S104, the main controller 125 instructs the output-mode changer 121 to select the input port A as an active input port. In this state, an electrically conductive path is formed from the power inlet 124 to the power outlet 122.

In step S105, the main controller 125 determines whether the battery cells 111 (or the power source 100) are fully charged or not, based on the electric voltage of the serially-interconnected battery modules 110, which has been detected by the voltage detector 127, and/or based on a signal received from the battery module controller 115 of each battery module 110, to thereby perform a charge control in step S108 (the branch of step 105 is “No”), or, to thereby stop a charging operation in step S106 (the branch of step S105 is “Yes”).

If the charging operation is stopped at step S106, then the process proceeds to step S107 to activate the display 104 to display a visual message to the user, which indicates that the battery cells 111 (or the power source 100) are fully charged. The process proceeds to steps S115 and S116 as described below.

While the charging operation is in progress in step S108, the display 104 indicates to the user that the charging operation is in progress in step S109. In an example, in order to notify the user of the time-varying status of the power source 100 being charged, it is preferable to indicate a time-varying level of a state-of-charge (hereinafter, abbreviated as “SOC”) of the battery cell group or the power source 100. It is noted that, while the battery cell group is being charged by the charging circuit 123, the inverter circuit 120 is kept inactive.

In step S110, the main controller 125 determines, based on a signal received from the input detector 129, whether AC voltage is being inputted into the power inlet 124, during the charging operation. If so, then the process returns to step S105 to keep the charging operation (the branch of step S110 is “Yes”), and if not so, then the process proceeds to step S111 (the branch of step S110 is “No”).

It is added that, while the charging operation is in progress with the output-mode changer 121 selecting the input port A, AC voltage can flow from the power inlet 124 directly to the power outlet 122 in a bypass manner. It is also added that AC voltage inputted into the power inlet 124 may be supplied from the commercial power source, or from the power outlet 122 of another power source 100 through the cable 140, and, in any case, AC voltage outputted from the power outlet 122 comparable to AC voltage inputted into the power inlet 124.

In step S111, the main controller 125 instructs the output-mode changer 121 to select the input port B as an active input port. In this state, a first path is formed from the battery modules 110 to the power outlet 122 through the inverter circuit 120 for outputting AC voltage from the power outlet 122, and a second path is formed from the power inlet 124 to the battery modules 110 through the charging circuit 123 for charging the battery modules 110.

In step S112, the main controller 125 determines whether the SOC level of the battery cells 111 is zero, based on the electric voltage of the serially-interconnected battery modules 110, which has been detected by the voltage detector 127, or based on a signal received from the battery module controller 115 of each battery module 110, to thereby activate the inverter circuit 120 to output electric power in step S117 (the branch of step S112 is “No”), or, to thereby deactivate the inverter circuit 120 in step S113 (the branch of step S112 is “Yes”).

If the inverter circuit 120 is deactivated in step S113, then the process proceeds to step S114 to activate the display 104 to display a visual message to the user, which indicates that the SOC level of the battery cells 111 is zero (or the battery cells are empty). The process proceeds to steps S115 and S116 as described below.

In step S115, the main controller 125 transmits to the battery module controller 115 of each battery module 110 a disable signal inhibiting the battery cells 111 from experiencing an electrical conduction state, and step S116 follows to allow the battery module controller 115 of each battery module 110 to receive the disable signal and turn off both the FETs 112 and 113. In this state, all of the battery modules 110 housed within the power source 100 has no electrical conduction, to prevent the inverter circuit 120 from outputting electric power, and to prevent the charging circuit 123 from charging. Therefore, this provides a reduction in power consumption of the power source 100, and ensures circuit reliability because of electrical isolation between possible electrically-conductive elements in case of failures.

When step S117 is implemented, the inverter circuit 120 is brought into an active state, and, in this state, step S118 is implemented to activate the display 104 to display a message to the user, which indicates that the inverter circuit 120 is in an active state. In an example, in order to notify the user of the time-varying status of the inverter circuit 120, it is preferable to indicate the time-varying SOC level of the battery cell group or the power source 100. It is noted that, in an active state of the inverter circuit 12, the charging circuit 123 is inactive.

In step S119, the main controller 125 determines, based on a signal from the input detector 129, whether AC voltage is inputted into the power inlet 124, in an active state of the inverter circuit 120. If not so, then the process returns to step S112 to keep the inverter circuit 120 active (the branch of step S119 is “No”), and if so, then the process proceeds to step S121 (the branch of step S119 is “Yes”).

In step S121, the main controller 125 determines a time lag T between a first time at which step S117 changed the inverter circuit 120 from its inactive state (at a time during this state, step S111 caused the output-mode changer 121 to change an active input port from the input port A into the input port B) into its active state, with the inverter circuit 120 inactive, and a second time at which step S119 determined that AC voltage was inputted into the power inlet 124, and the main controller 125 determines whether the determined time lag T is equal to or shorter than a predetermined threshold Tth. If so, then the process proceeds to step S122, and if not so, the process returns to step S104. The reasons why the time lag T is determined will be described below.

In step S122, a count value N is incremented by one (1), and the count value N is calculated by a counter of the main controller 125, which is configured in the form of not a physically-independent electrical circuit, but a function made by software. The reasons why the count value N is used will be also described below. In step S123, a determination is made as to whether the count value N is equal to or larger than predetermined threshold Nth that is equal to, for example, two (2). If so, then the process first proceeds to step S120 (the branch of step S123 is “Yes”) and then proceeds to step S124, and if not so, then the process returns to step S104 (the branch of step S123 is “No”). In step S120, the main controller 125 deactivates the inverter circuit 120. The fact that the count value N is not smaller than the threshold Nth implies that a loop-back connection of the power source 100 as described below has been surely detected, and therefore, step S124 is implemented to instruct the display 104 to display an error message (e.g., a message expressed by turning on/off a specific indicator lamp, or by displaying letters or specific pictures) to the user, which indicates the user had conducted an incorrect action for the power source 100 (i.e., terminals of the power source 100 has been mistakenly interconnected in are in a faulty connection).

Step S124 is followed by step S125 in which the main controller 125 transmits to the battery module controller 115 of each battery module 110 a disable signal for inhibiting the battery cells 111 from entering an electrical conduction state (i.e., from electrical interconnection of the battery cells 111), and is followed by step S116 in which the battery module controller 115 of each battery module 110 receives the disable signal and turn off both the FETs 112 and 113. This causes none of the battery modules 110 housed within the power source 100 encountering a loop-back connection to be situated in an electrical conduction state, to prevent the inverter circuit 120 from being active, and to prevent the charging circuit 123 from being active. Therefore, this can prevent the power source 100 encountering a loop-back connection from causing any failures.

It is added that, in order for the display 104 to keep displaying the error message, even after none of the battery modules 100 housed within the power source 100 encountering a loop-back connection has become incapable of having an electrical conduction state, the main controller 125 and the display 104 can be powered by the power supply circuit 126 instead of the battery modules 100.

Referring then to FIGS. 3-5, the configuration of the power source 100 that encounters a loop-back connection, and an exemplary control technique according to the present embodiment which secures reliability of the power source 100 in the event of the loop-back connection will be described in more detail.

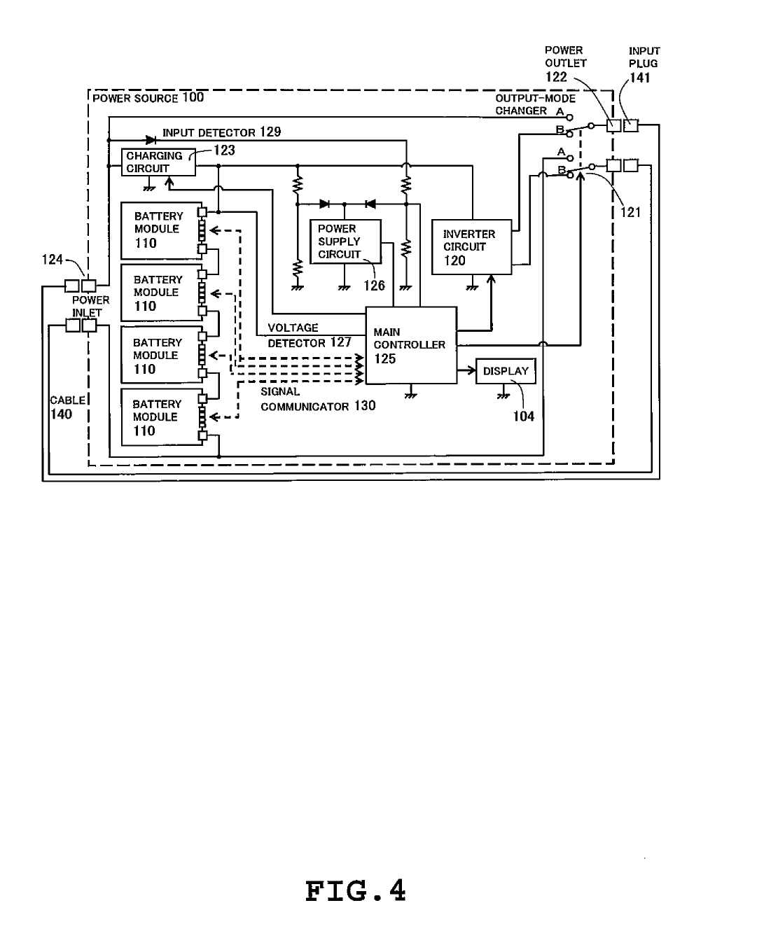

FIG. 4 is a functional block diagram illustrating the power source 100 in loop-back connection.

The input plug 141 of the cable 140 connected with the power source 124 is connected with a power outlet 122, to thereby form a loop-back connection. A control flow of the power source 100 in this state will be described with reference to FIG. 3. It is added that the SOC level of the battery cells 111 is assumed not to be zero (0). In addition, although will be described below in more detail, it is assumed that an initial value of the count value N handled in step S122 is set to zero (0), and the threshold Nth handled in step S123 is set to two (2).

As illustrated in FIG. 4, when the output-mode changer 121 selects the input port A as an active input port, the power inlet 124 and the power outlet 122 are at equal potential, because of establishment of a self-inclusive loop-back connection depicted in FIG. 4, meaning that both the power inlet 124 and the power outlet 122 are at zero (0) volts. As a result, in step S103, the main controller 125 detects, through the input detector 129, that a voltage detection point is at zero (0) volts, and determines that AC voltage is not inputted into the power inlet 124. The process then proceeds to step S111.

The main controller 125, when implementing step S117, instructs the output-mode changer 121 to select the input port B as an active input port, and then, when implementing step S117, activates the inverter circuit 120 to begin an inverter outputting operation. AC voltage outputted from the inverter circuit 120 is inputted into the power inlet 124 through the power outlet 122 and the input plug 141 of the cable 120, as illustrated in FIG. 4 depicting a self-inclusive loop-back connection.

In step S119, the main controller 125 detects, through the input detector 129, application of AC voltage into the power inlet 124, and the process proceeds to step S121.

In step S119, the main controller 125 determines the time lag T between a first time at which step S117 changed the inverter circuit 120 from its inactive state (at a time during this state, step S111 caused the output-mode changer 121 to change an active input port from the input port A into the input port B) into its active state, with the inverter circuit 120 inactive, and a second time at which step S119 determined that AC voltage was inputted into the power inlet 124. The length of the time lag T is measured by a timer or the counter included within the main controller 125. When the power source 100 is experiencing a loop-back connection, AC voltage produced by the inverter circuit 120 is detected by the input detector 129 immediately after the inverter circuit 120 is activated to generate the AC voltage as a result of the implementation of step S117, and therefore, the time lag T is very short in length, which is not longer than, for example, 0.1 seconds. As a result, if the time lag T is equal to or shorter than the predetermined threshold Tth, for example, one (1) second, then the process proceeds to step S122.

In an alternative implementation, at a time when it is first determined that T <=Tth is satisfied (the branch of step S121 first becomes “Yes”), it is determined that the power source 100 is experiencing a loop-back connection in effect. To put it another way, it can be reasonably assumed that, because there is little likelihood that the user inserts the input plug 141 of the cable 120 into the outlet of the commercial power source simultaneously with the activation of the inverter circuit 120, an event expressed by T<=Tth occurs only when the power source 100 encounters a loop-back connection. Therefore, if it is determined in step S121 that a loop-back connection has been made, then the process may proceed to step S124 by way of step S120 by skipping steps S122 and S123.

When it has been determined that T>Tth is satisfied (the branch of step S121 is “No”), it is not that the input detector 129 has detected application of AC voltage outputted from the inverter circuit 120 to the power inlet 124 immediately after the inverter circuit 120 is activated, and therefore, it can be estimated that the user does not make a loop-back connection, but connects the input plug 141 of the cable 140 with the outlet of the commercial power source or a power outlet 122 of another power source 100.

In the present embodiment, the time lag T is determined as a time interval between a first time at which step S117 changed the inverter circuit 120 from its inactive state (at a time during this state, step S111 caused the output-mode changer 121 to change an active input port from the input port A into the input port B) into its active state, with the inverter circuit 120 inactive, and a second time at which step S119 determined that AC voltage was inputted into the power inlet 124.

In an alternative implementation, the output-mode changer 121 is removed, a direct current path does not exist from the power inlet 124 to the power outlet 122 for outputting AC voltage, only a path remains from the battery modules 110 to the power outlet 122 via the inverter circuit 120 for outputting AC voltage, a time lag T′ is determined as a time interval between a first time when the inverter circuit 120 became active to start outputting power, and a second time when application of AC voltage to the power inlet 124 was detected, and the time lag T′ is used in the same manner the time lag T is used in the previous embodiment, resulting in the same results. This implies that the invention can detect a loop-back connection, irrespective of whether the output-mode changer 121 is employed or not.

Steps S122 and S123 form a determination sequence for increasing a precision with which a determination is made as to whether a loop-back connection is made or not. While there is little likelihood that the user inserts the input plug 141 of the cable 140 into the outlet of the commercial power source simultaneously with the activation of the inverter circuit 120, it is also predicted that, although it is rare, the determination of the above-described step S121 is “Yes,” because the user has inserted the input plug 141 into the outlet of the commercial power source for the purpose of charging the power source 100 by use of the commercial power source.

If step S121 is implemented to determine that T<=Tth is satisfied, then step S122 follows to increment the count value N into “1.” In this case, it is determined, in step S123, that the count value N is smaller than the threshold Nth, i.e., “2,” and as a result, the process returns to step S104.

The main controller 125 instructs the output-mode changer 121 to select the input port A as an active input port in step S104, and subsequently activates the charging circuit 123 in step S108. The power source 100, however, has a loop-back connection made by means of the cable 140, it is determined in step S110 that the power inlet 124 is at zero (0) volts, and the process proceeds to step S111.

After step S111, the process proceeds again to step S123, with the same sequence as the foregoing. In this state, because the count value N is two (2), and because it is determined in step S123 that the count value N is equal to or larger than the threshold Nth, i.e., two (2), the process proceeds to step S124, by way of step S120. This would allow a loop-back connection to be detected without misjudgment, allow the error message to be surely presented to the user, and allow each circuit to be surely deactivated, to thereby prevent a failure. This process using the counter value N can detect a loop-back connection, irrespective of whether the output-mode changer 121 is employed or not, as described above.

As will be evident from the foregoing explanation, in the present embodiment, a determination is made as to whether voltage applied to the power inlet 124 of the power source 100 is the same as AC voltage outputted from the power outlet 122, for ultimate determination of presence/absence of a loop-back connection, using the input detector 129 and the above-described timer, based on the fact that, when a loop-back connection is made, AC voltage is outputted from the power outlet 122 of the power source 100, with a distinguishable voltage/time profile (e.g., a characteristic representing that the time lag T is not longer than the threshold Tth).

As will be understood, in the present embodiment, the four battery modules 110 constitute an example of the “battery cell group” set forth in the above mode (1), the inverter circuit 120 constitutes an example of the “power-output section” set forth in the same mode, the power outlet 122 constitutes an example of the “power-output terminal” set forth in the same mode, the charging circuit 123 constitutes an example of the “charger” set forth in the same mode, the power inlet 124 constitutes an example of the “power-input terminal” set forth in the same mode, the input detector 129 constitutes an example of the “detector” set forth in the same mode, and a portion of the main controller 125 which is assigned to implement steps S117 and S121 depicted in FIG. 3 constitutes an example of the “determining section” set forth in the same mode.

While an exemplary embodiment of a process for ensuring reliability of one unit of the power source 100 with a self-inclusive loop-back connection, a loop-back connection can be made for a set of units of the power sources 100.

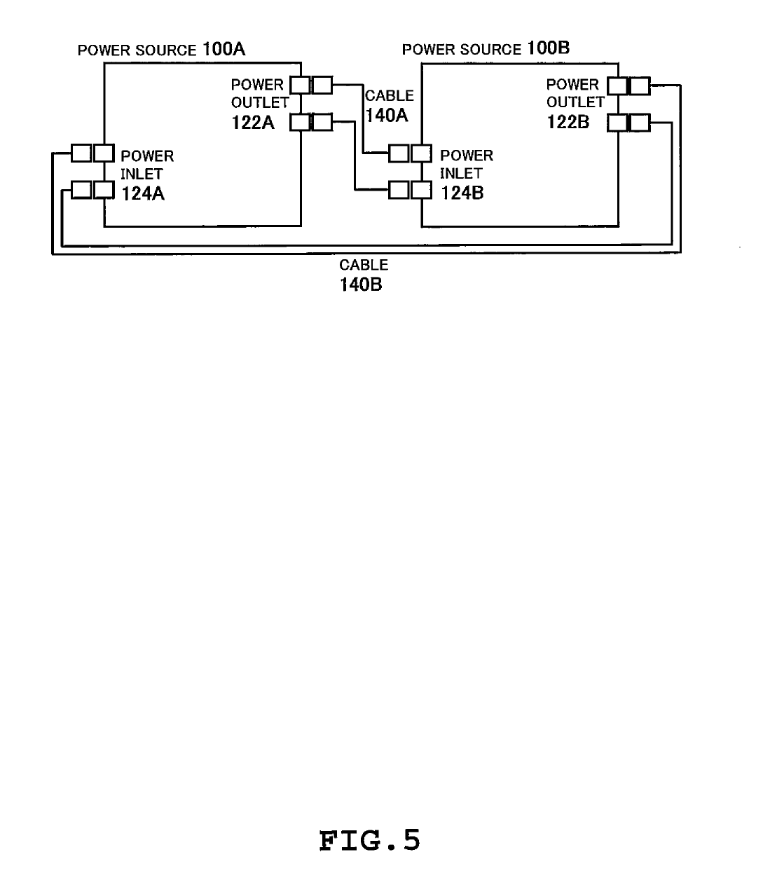

FIG. 5 is a functional block diagram illustrating two power sources 100A and 100B with a loop-back connection (or a non-self-inclusive loop-back connection).

A cable 140A connected with a power outlet 122A of the power source 100A is connected with a power inlet 124B. On the other hand, a cable 140B connected with a power outlet 122B of the power source 100B is connected with a power inlet 124A. This causes the two power sources 100A and 100B to experience a loop-back connection (or a non-self-inclusive loop-back connection).

Also in this case, each power source 100A, 100B operates in accordance with the above-described control sequence, to determine whether a loop-back connection is made in each power source 100A, 100B, and if so, each power source 100A, 100B deactivates each circuit, and displays an error message. This implies that, also for a set of units of power sources, a loop-back connection can be detected. Additionally, for achieving this goal, there is no need for new additional terminals or circuits, and therefore, a highly reliable system can be provided without increasing the cost of the system.

Reference throughout the specification to “one embodiment” or “an embodiment” means that a particular feature, structure, or characteristic described in connection with the embodiment is included in at least one embodiment of the present invention.

Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A battery system comprising:
a battery assembly;
an AC-voltage generator for generating alternate current (AC) voltage from direct current (DC) voltage of the battery assembly;
a battery charger for charging the battery assembly; and
a detector for detecting application of AC voltage from the AC-voltage generator to the battery charger.

2. The battery system of claim 1, further comprising an electrically-operated switch configured to operate such that, in the presence of AC voltage inputted into the battery charger, the switch connects an output port of the AC-voltage generator with an input port of the battery charger, and, in the absence of AC voltage inputted into the battery charger, the switch does not connect the output port of the AC-voltage generator with the input port of the battery charger.

3. The battery system of claim 1, further comprising a controller configured to at least partially inhibiting the AC-voltage generator from affecting the battery charger, in response to detection of the application of the AC voltage from the AC-voltage generator to the battery charger.

4. The battery system of claim 1, further comprising an indicator providing an indication varying in response to detection of the application of the AC voltage from the AC-voltage generator to the battery charger.
